(19) United States
(12) Patent Application Publication
(10) Pub. No.: US 2013/0006575 A1
(43) Pub. Date: Jan. 3, 2013

(54) FAN ROTATION SPEED TEST DEVICE

(75) Inventors: Yong-Jun SONG, Shenzhen City (CN); Yong-Zhao HUANG, Shenzhen City (CN)

(73) Assignees: HON HAI PRECISION INDUSTRY CO., LTD., Tu-Cheng (TW); HONG FU JIN PRECISION INDUSTRY(SheZhen) CO., LTD., Shenzhen City (CN)

(21) Appl. No.: 13/247,003

(22) Filed: Sep. 28, 2011

(30) Foreign Application Priority Data
Jun. 28, 2011 (CN) 201110177091.2

(51) Int. Cl. G01P 3/00; G06F 15/00

(52) U.S. Cl. 702/145

(57) ABSTRACT

A fan rotation speed test device connected to a computer includes an information processing chip, an indicating unit, and an interface. The interface is compatible with a memory socket on a mainboard of the computer. The computer transfers control instructions to the information processing chip via the interface. After receiving the control instructions, the information processing chip outputs PWM signals by executing programs therein to modulate the rotation speed of a fan. The information processing chip collects rotation speed signals of the fan, then judges if the rotation speed of the fan is according to a predetermined standard by executing arithmetic programs. The information processing chip outputs test result signals to the indicating unit for display.

### BACKGROUND

1. Technical Field

The present disclosure relates to test devices, and particularly to a test device which has an interface compatible with a computer and can test rotation speed of a fan.

2. Description of Related Art

One test device used in a laboratory for testing rotation speed of fans has a very complicated structure. An additional communication interface is needed to connect the test device with a computer. As a result of the additional interface, the communication between the test device and the computer is slow, and test efficiency of the test device is very low.

What is needed, therefore, is a fan rotation speed test device which can overcome the limitations described.

### BRIEF DESCRIPTION OF THE DRAWINGS

FIG. 1 is a constitution block diagram of a fan rotation speed test device in accordance with an exemplary embodiment of the disclosure.

FIG. 2 shows a part of a circuit of the fan rotation speed test device of FIG. 1.

FIG. 3 shows another part of the circuit of the fan rotation speed test device of FIG. 1.

### DETAILED DESCRIPTION

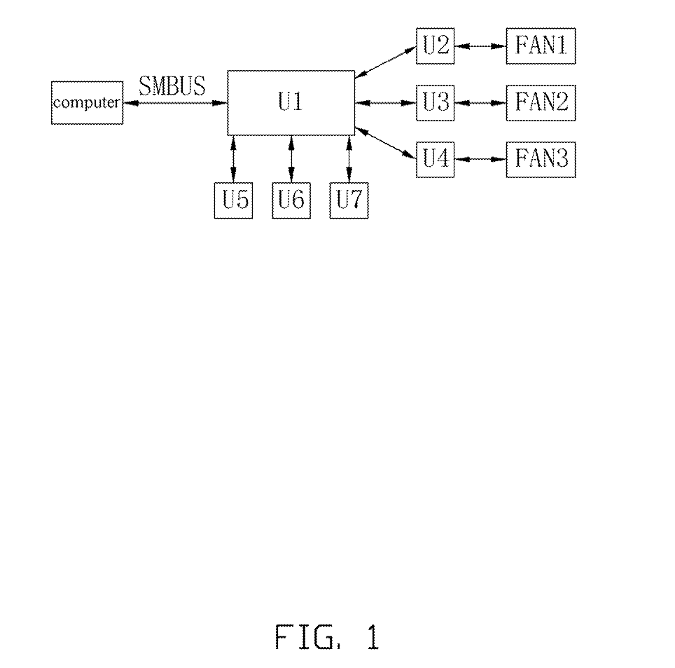

Referring to FIG. 1, a fan rotation speed test device according to an exemplary embodiment of the disclosure includes an information processing chip U1, three signal amplifying units U2-U4, and three indicating units U5-U7. The fan test device can test rotation speed of three fans FAN1-FAN3 simultaneously.

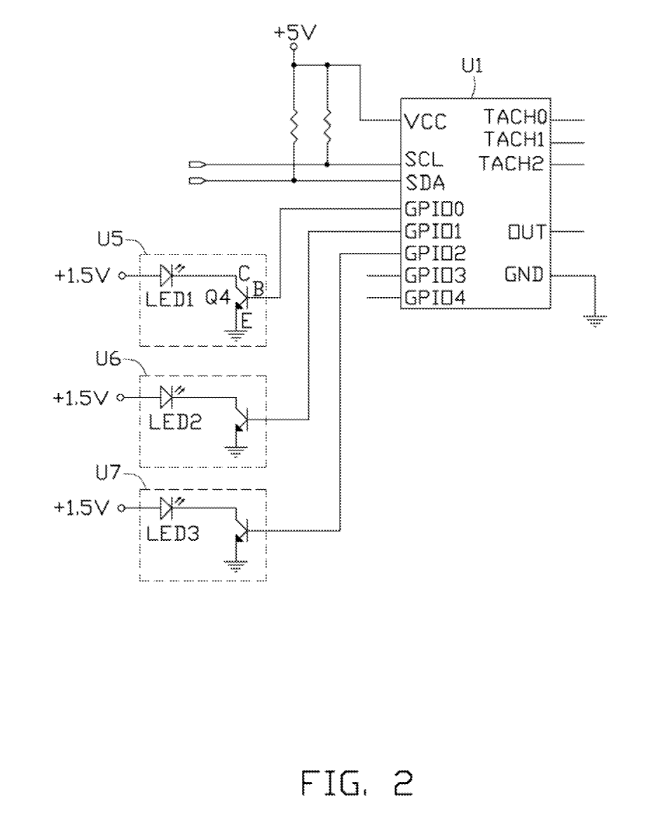

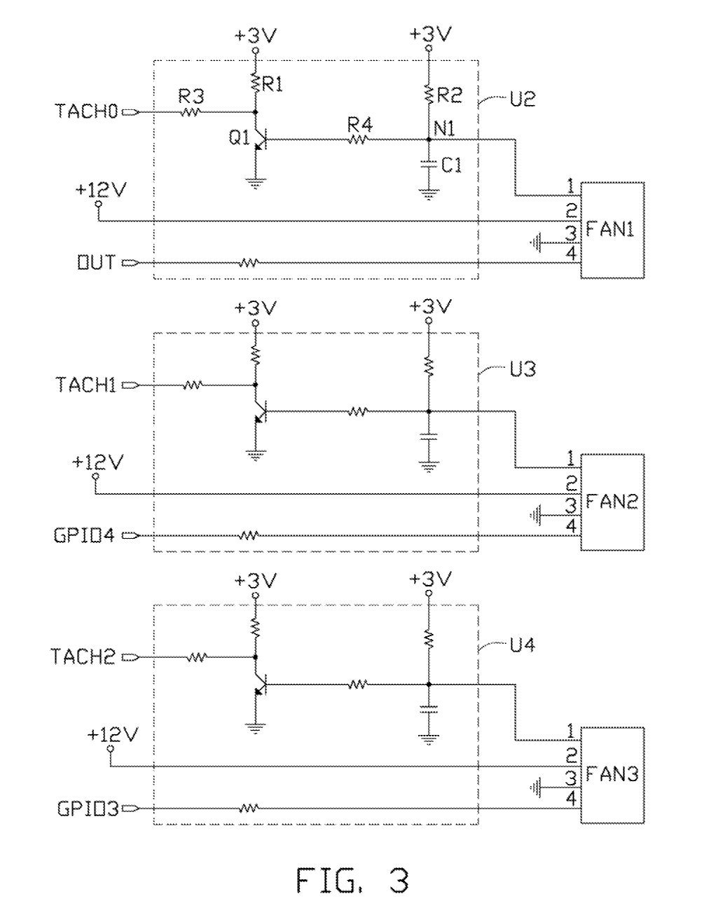

Also referring to FIGS. 2-3, the chip U1 is a MAX6651. Pins SCL and SDA of the chip U1 connect to an interface SMBUS (System Management Bus). The interface SMBUS is compatible with a memory socket on a mainboard of a computer. When the fan test device is connected to the computer via the interface SMBUS, communication between the fan device and the computer is established. The pins SCL and SDA and a pin VCC of the information processing chip U1 connect to a 5-volt direct current power source. A pin GND of the information processing chip U1 connects to ground.

Each fan has four pins 1-4. The pins 1 of the fans FAN1-FAN3 connect to the signal amplifying units U2-U4 respectively. The pins 2 of the fans FAN1-FAN3 connect to a 12-volt direct current power source. The pins 3 of the fans FAN1-FAN3 connect to ground. The pins 4 of the fans FAN1-FAN3 connect to pins GPIO3, GPIO4, OUT of the chip U1 respectively.

The signal amplifying units U2-U4 all have the same structure, so only the signal amplifying unit U2 is explained below for simplicity. The signal amplifying unit U2 includes a transistor Q1, four resistors R1-R4, and a capacitor C1. The resistor R4 is connected between the pin 1 of the fan FAN1 and a base B1 of the transistor Q1, and the resistor R4 has a 4.7 kilo-ohm resistance. A node N1 is formed between the resistor R4 and the pin 1 of the fan FAN1. The resistor R2 is connected between the node N1 and a 3-volt direct current power source, and the resistor R2 is also a 4.7 kilo-ohm resistor. The capacitor C1 is connected between the node N1 and ground, and has a capacitance of 0.1 microfarads. An emitter E1 of the transistor Q1 is connected to ground. The resistor R3 is connected between a pin TACH0 of the chip U1 and a collector C1 of the transistor Q1, and the resistor R3 is a 220 ohm resistor. The resistor R1 is connected between the collector C1 and the 3-volt direct current power source, and the resistor R1 is a 1 kilo-ohm resistor.

The indicating units U5-U7 all have the same structure, so only the indicating unit U5 is explained below for simplicity. The indicating unit U5 includes a transistor Q4, and a light-emitting diode LED1. A base B4 of the transistor Q4 is connected to a pin GPIO0 of the chip U1. An emitter E4 of the transistor Q4 is connected to ground.

A cathode of the LED1 is connected to a collector C4 of the transistor Q4. An anode of the LED1 is connected to a 1.5-volt direct current power source.

In use of the fan test device, the computer transmits control instructions to the chip U1 via the interface SMBUS. After receiving the control instructions, the chip U1 executes programs therein, and pins GPIO3, GPIO4, OUT of the chip U1 outputs pulse width modulation (PWM) signals to modulate rotation of the fans FAN1-FAN3. The pins TACH0-TACH2 of the chip U1 collect actual rotation speed signals of the fans FAN1-FAN3. Before the actual rotation speed signals of the fans FAN1-FAN3 are transferred to the chip U1, they are amplified by the amplifying units U2-U4. The chip U1 then determines if the actual rotation speeds of the fans FAN1-FAN3 meet a predetermined standard by executing arithmetic programs in the chip U1. Pins GPIO0-GPIO2 of the chip U1 output signals indicating test results to the indicating units U5-U7. The transistors of the indicating units U5-U7 amplify the test result signals. For the test results of the fans FAN1-FAN3 are up to standard, the corresponding light-emitting diodes LED1-LED3 of the indicating units U5-U7 will light steadily. When the test results of the fans FAN1-FAN3 are not up to standard, the corresponding light-emitting diodes LED1-LED3 will flash. In addition, by executing the programs in the chip U1, the test results of the fans FAN1-FAN3 can be transferred to the computer via the interface SMBUS, and displayed by a screen of the computer.

According to the disclosure, the interface SMBUS of the fan test device is compatible with the memory socket on the mainboard of the computer, and an additional interface for connecting the fan rotate speed test device with the computer is not needed. Thus, communication between the test device and the computer will be faster, and testing efficiency of the fan test device is improved.

It is to be understood, however, that even though numerous characteristics and advantages of the disclosure have been set forth in the foregoing description, together with details of the structure and function of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A fan rotation speed test device comprising:
an interface compatible with a memory socket of a computer;
an information processing chip coupled to the interface; and
an indicating unit coupled to the information processing chip, the information processing chip outputting PWM signals to modulate the rotation speed of a fan according to control instructions of the computer, and collecting actual rotation speed signals of the fan, determining if the actual rotation speed signals of the fan meet a predetermined standard, the information processing chip outputting a test result signal of the fan to the indicating unit for display.

2. The fan rotation speed test device of claim 1, further comprising a signal amplifying unit, before the actual rotation speed signals of the fan being collected by the information processing chip, the actual rotation speed signals of the fan being amplified by the signal amplifying unit.

3. The fan rotation speed test device of claim 1, wherein the indicating unit comprises a light-emitting diode, when the test result of the rotation speed of the fan being up to standard, the light-emitting diode of the indicating unit will light steadily, when the test result of the rotation speed of the fan being not up to standard, the light-emitting diode of the indicating unit will flash.

4. The fan rotation speed test device of claim 3, wherein the indicating unit further comprises a transistor connecting the light-emitting diode, before the test result signal being displayed by the light-emitting diode of the indicating unit, the level signal being amplified by the transistor of the indicating unit.

5. The fan rotation speed test device of claim 4, wherein the transistor comprises an emitter, a base, and a collector, the base connecting the information processing chip, the emitter connecting ground, the collector connecting the light-emitting diode.

6. The fan rotation speed test device of claim 1, wherein before the test result signal is displayed by the indicating unit, the test result signal is amplified by the indicating unit.

7. The fan rotation speed test device of claim 1, wherein the information processing chip is capable of outputting the test result of the rotation speed of the fan to the computer via the interface.
